(19) United States
(12) Patent Application Publication
(10) Pub. No.: US 2015/0107256 A1
(43) Pub. Date: Apr. 23, 2015

(54) COMBUSTOR FOR GAS TURBINE ENGINE

(71) Applicant: PRATT & WHITNEY CANADA CORP., Longueuil (CA)

(72) Inventors: Lev Alexander Prociw, Johnston, IA (US); Darien Sussman, Toronto (CA); Oleg Morenko, Oakville (CA)

(73) Assignee: PRATT & WHITNEY CANADA CORP., Longueuil (CA)

(21) Appl. No.: 14/056,485

(22) Filed: Oct. 17, 2013

(51) Int. Cl. F23R 3/28; F23R 3/00; F02C 7/22

(52) U.S. Cl. CPC F23R 3/283; F02C 7/222; F23R 3/002
USPC 60/739

(57) ABSTRACT

An assembly of a combustor and fuel manifold comprises a fuel manifold having at least an annular portion with a plurality of fuel outlets facing at least partially radially inward. A combustor comprises an annular inner liner and an annular outer liner spaced apart from the inner liner, the inner liner and outer liner concurrently forming an annular combustor chamber therebetween. The inner and outer liners concurrently define an annular receptacle in the annular combustor chamber for receiving the fuel manifold. The inner liner and outer liners are shaped to define an annular gas path in the annular combustor chamber having an upstream portion that is substantially radial and oriented toward a center when the combustor is in a gas turbine engine.

### FIELD OF THE INVENTION

The present application relates to gas turbine engines and to a combustor thereof.

### BACKGROUND OF THE ART

In conventional gas turbine engine, combustors have geometries such as reverse-flow and slinger. Accordingly, the combustors occupy a non-negligible volume of the plenum in the turbine case, which may impact gas flow. Improvement is desirable.

### SUMMARY

In accordance with an embodiment of the present disclosure, there is provided an assembly of a combustor and fuel manifold, the assembly comprising: a fuel manifold having at least an annular portion with a plurality of fuel outlets facing at least partially radially inward; and a combustor comprising an annular inner liner and an annular outer liner spaced apart from the inner liner, the inner liner and outer liner concurrently forming an annular combustor chamber therebetween, the inner and outer liners concurrently defining an annular receptacle in the annular combustor chamber for receiving the fuel manifold, the inner liner and outer liners being shaped to define an annular gas path in the annular combustor chamber having an upstream portion that is substantially radial and oriented toward a center when the combustor is in a gas turbine engine

In accordance with another embodiment of the present disclosure, there is provided a gas turbine engine comprising: a combustor comprising an annular inner liner and an annular outer liner spaced apart from the inner liner, the inner liner and outer liner concurrently forming an annular combustor chamber therebetween, the inner and outer liners concurrently defining an annular receptacle in the annular combustor chamber, the inner liner and outer liners being shaped define an annular gas path in the annular combustor chamber having an upstream portion that is substantially radial and oriented toward a center when the combustor is in a gas turbine engine; and a fuel manifold received in the annular receptacle, the fuel manifold having fuel outlets facing toward a center of the gas turbine engine and adapted to inject fuel radially in the upstream portion of the annular gas path

### DESCRIPTION OF THE DRAWINGS

FIG. 1 is a longitudinal sectional view of a gas turbine engine with a combustor assembly in accordance with the present disclosure; and

FIG. 2 is an enlarged view of the gas turbine engine of FIG. 1, showing the combustor in greater detail.

FIG. 3 is a schematic view showing an example of suitable dimensions for the combustor of FIG. 2; and

FIG. 4 is an enlarged schematic view showing a relation between manifold and combustor.

### DESCRIPTION OF THE EMBODIMENT

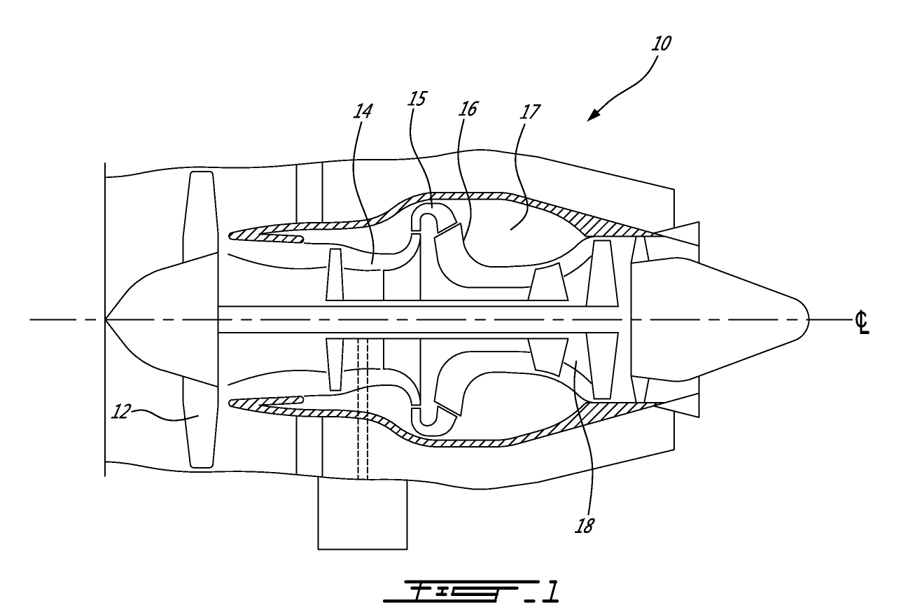

FIG. 1 illustrates a turbofan gas turbine engine 10 of a type preferably provided for use in subsonic flight, generally comprising in serial flow communication a fan 12 through which ambient air is propelled, a multistage compressor 14 for pressurizing the air, a plurality of curved radial diffuser pipes 15 in this example, a combustor 16 in which the compressed air is mixed with fuel and ignited for generating an annular stream of hot combustion gases, a plenum 17 defined by the casing and receiving the radial diffuser pipes 15 and the combustor 16, and a turbine section 18 for extracting energy from the combustion gases.

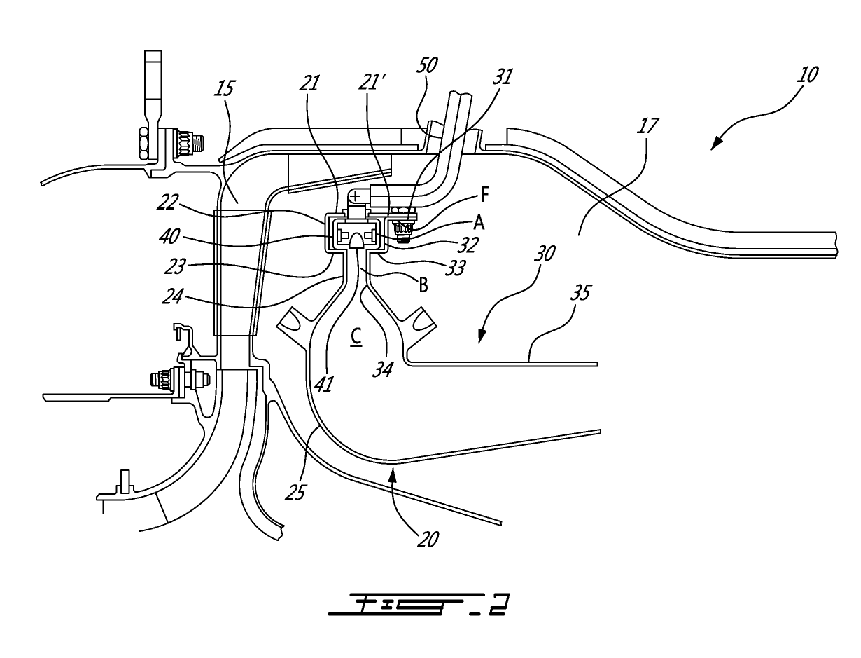

Referring to FIG. 2, the combustor 16 is has a radial-to-axial geometry, with reference to a gas path therein, with an upstream end being radial relative to a longitudinal axis of the gas turbine engine 10, and a downstream end being axial. By The combustor 16 has an annual geometry with an inner liner 20 and an outer liner 30 defining therebetween an annular combustor chamber in which fuel and air mix and combustion occurs. As shown in FIG. 2, a fuel manifold 40 is positioned inside the combustion chamber and therefore between the annular inner liner 20 and the annular outer liner 30. A fuel line 50 is in fluid communication with the fuel manifold 40 to supply fuel. Although a single fuel line 50 is shown and used in FIG. 2, additional fuel lines 50 may be provided as well.

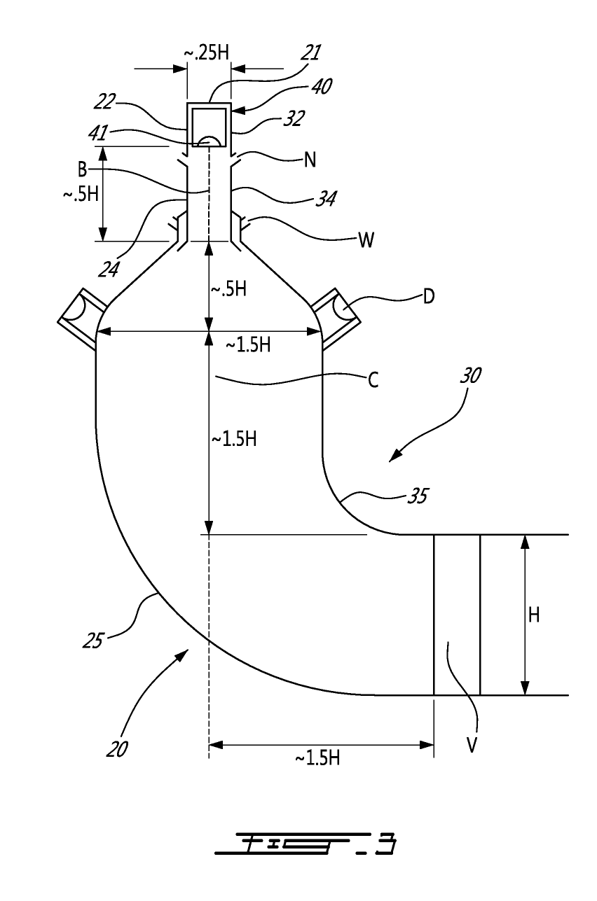

In the illustrated embodiment, an upstream end of the combustor 16 has a sequence of zones, namely zones A, B, and C. The manifold 40 is in upstream zone A. Mixing throat zone B is downstream of zone A, and is a narrow passage of the combustor. Subsequently, in dilution zone C, the combustor 16 flares to allow dilution air to mix with the fuel and nozzle air mixture coming from zone B of the combustor 16. Additionally, wall cooling air enters from dilution zone B to cool the inner liner 20 and outer liner 30. The overall geometry of the combustor 16 is defined by the zones A and B being radially oriented relative to the longitudinal axis of the gas turbine engine 10, and with zone C continuing radially after flaring and then curving into a longitudinal orientation at the outlet of the combustor 16. There is provided in FIG. 3 an example of dimensional ratios between the various components of the combustor 16, relative to a height H of a turbine vane inlet V.

Both the inner liner 20 and the outer liner 30 may be a single integral annular piece, for instance of regular sheet metal, that may be machined, bent, formed etc into the shapes described hereinafter. Alternatively, the liners 20 and 30 may be constituted of a plurality of pieces interconnected, and other materials could be used such a ceramic composite materials. Because of their small size and simple geometry over prior art combustors, shells for the liners 20 and 30 could be constructed of ceramic composite materials which could be considered too expensive for conventional, larger combustors with numerous holes and cooling features.

In the illustrated embodiment, the inner liner 20 has a geometry defined by a sequence of segments by which the inner liner 20 will house the manifold 40, and form the inner portion of the combustion chamber with the radial-to-quasiaxial shape shown in FIG. 2. The inner liner 20 has a liner segment 21 through which the fuel line 50 reaches the manifold 40, wherein there is a passage in the liner segment 21 for each of the fuel lines 50 if there are more than one. Moreover, the manifold 40 may be supported by the liner segment 21 to remain in position in the combustor 16. The liner segment 21 extends in a generally or substantially axial direction of the gas turbine engine 10, i.e., parallel to the longitudinal axis of the gas turbine engine 10. The liner segment 21 therefore defines an outer circumferential surface of the combustor 16. The liner segment 21 has a tab portion 21′ that extends beyond the manifold 40, and that is used to be secured to the outer liner 30, as described hereinafter.

A liner segment 22 is at an end of the liner segment 21 away from the tab portion 21′, and is generally transverse relative to the liner segment 21. Accordingly, the liner segment 22 is generally radial as it lies in a plane that is generally or substantially normal arrangement with the longitudinal axis of the gas turbine engine 10. The liner segment 22 forms part of zone A with the liner segment 21, housing the manifold 40.

Still referring to FIG. 2, a liner segment 23 is at an end of the liner segment 22 away from the liner segment 21, and is generally transverse relative to the liner segment 22. Accordingly, the liner segment 23 is parallel to the longitudinal axis of the gas turbine engine 10. The liner segment 23 forms part of zone A with the liner segments 21 and 22, housing the manifold 40.

A liner segment 24 is at an end of the liner segment 23 away from the liner segment 22, and is generally transverse relative to the liner segment 23. Accordingly, the liner segment 24 is generally radial as it lies in a plane that is in a generally or substantially normal arrangement with the longitudinal axis of the gas turbine engine 10. The liner segment 22 forms part of mixing zone B.

Liner segment 25 is at the end of the liner segment 24 away from the liner segment 23. The liner segment 25 flares from the liner segment 24 to define zone C and the combustion zone, and subsequently turns into a quasi-axial orientation. The downstream end of the liner segment 25 may diverge away from the longitudinal axis of the gas turbine engine 10 in the manner shown in FIG. 2, although parallel and converging orientations could also be used. The liner segment 25 is the downstream segment of the inner liner 20. The end of the liner segment 25 is aligned with the turbine section 18, to guide combustion products thereto.

Still referring to FIG. 2, the outer liner 30 is also constituted of a sequence of segments by which the outer liner 30 will house the manifold 40 with the inner liner 20, and form the outer portion of the combustion chamber with the radial-to-quasiaxial shape shown in FIG. 2. The outer liner 30 has a liner segment 31 that extends in a generally or substantially axial direction of the gas turbine engine 10, i.e., parallel to the longitudinal axis of the gas turbine engine 10. The liner segment 31 that extends beyond the manifold 40, and that is used to be secured to the inner liner 20, with the liner segments 21 and 31 being applied against one another and secured by way of fasteners F. The liner segments 21 and 31 may have contacting circumferential surfaces as in FIG. 2. The fasteners F are shown as being bolts and nuts, although other fastening means are considered, such as rivets and like mechanical fasteners, etc, provided such fasteners offer sufficient fastening strength between the inner liner 20 and outer liner 30. The use of mechanical fasteners may allow the access to an interior of the combustor 16. The liner segments 21 and 31 are against one another and extend axially toward the rear of the gas turbine engine 10, although other orientations are possible, such as radial, forward extension, etc.

A liner segment 32 is at an end of the liner segment 31, and is generally transverse relative to the liner segment 31. Accordingly, the liner segment 32 is generally radial as it lies in a plane that is generally or substantially normal arrangement with the longitudinal axis of the gas turbine engine 10. The liner segment 32 is generally parallel to the liner segment 22. The liner segment 32 forms part of zone A, housing the manifold 40. The manifold 40 in such arrangement has its nozzles oriented radially inward, hence injecting fuel in a generally radially inward direction relative to the longitudinal axis of the gas turbine engine 10. The various segments of the liners 20 and 30 defining the annular receptacle for the manifold 40 may be symmetrical as in FIG. 2.

Still referring to FIG. 2, a liner segment 33 is at an end of the liner segment 32 away from the liner segment 31, and is generally transverse relative to the liner segment 32. Accordingly, the liner segment 33 is parallel to the longitudinal axis of the gas turbine engine 10, and is shown as being axially aligned with the liner segment 23 of the inner liner 20. The liner segment 33 forms part of zone A with the liner segments 32, housing the manifold 40.

A liner segment 34 is at an end of the liner segment 33 away from the liner segment 32, and is generally transverse relative to the liner segment 33. Accordingly, the liner segment 34 is generally radial as it lies in a plane that is in a generally or substantially normal arrangement with the longitudinal axis of the gas turbine engine 10. The liner segment 32 forms part of mixing zone B, with the liner segment 22 of the inner liner 20.

Liner segment 35 is at the end of the liner segment 34 away from the liner segment 33. The liner segment 35 flares from the liner segment 34 to define zone C and the combustion zone, and subsequently turns into an axial orientation. The downstream end of the liner segment 35 may be generally parallel the longitudinal axis of the gas turbine engine 10 in the manner shown in FIG. 2, although diverging and converging orientations could also be used. The liner segment 35 is the downstream segment of the outer liner 30. The end of the liner segment 35 is aligned with the turbine section 18, to guide combustion products thereto.

Although not shown, it is pointed out that air holes may be defined where appropriate in the inner liner 20 and the outer liner 30. For instance, there is shown in FIGS. 2 and 3 block components mounted onto the liner segments 25 and 35 that are used to guide air into the combustor 16.

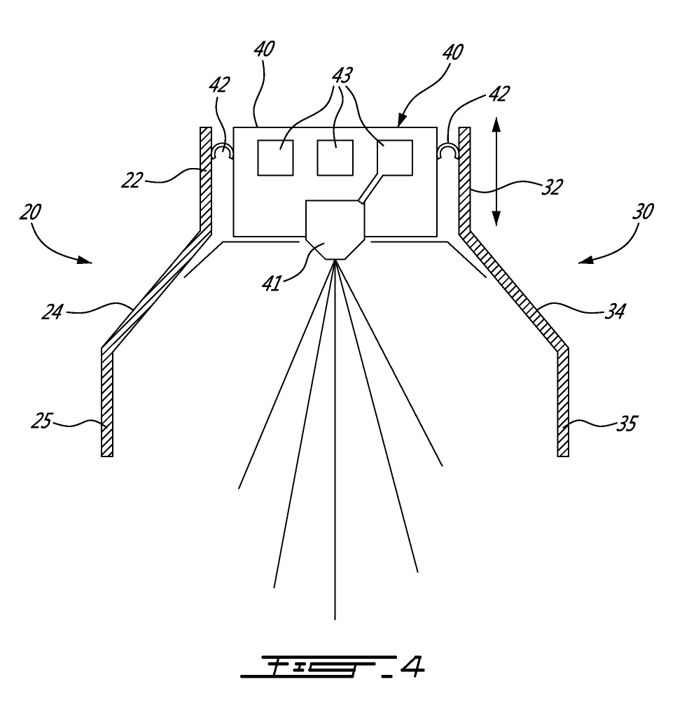

Referring to FIGS. 2 and 4, as discussed above, the manifold 40 is an annular manifold that is located inside the combustor 16. The manifold 40 is schematically shown as having fuel injector sites 41 facing radially inward, i.e., toward a centerline of the gas turbine engine 10. The fuel injector sites 41 are provided in sufficient numbers to provide a substantially consistent annular flow of atomized fuel from its circumference, hence the manifold 40 may be described as an annular nozzle for the annular flow. The manifold 40 may be in the form of a full ring, or a segmented ring, within the annular receptacle defined by the inner liner 20 and the outer liner 30. The fuel injector sites 41 are circumferentially distributed in the manifold 40 and may be oriented with a tangential component relative to the engine centerline. As the manifold 40 is connected to the combustor 16 and is inside the combustor 16, there is no relative axial displacement between the combustor 16 and the manifold 40. The orientation of the fuel injector sites 41 into the radial (or radial/tangential) direction greatly simplifies the sealing of the manifold 40 and combustor liners 20 and 30. As shown in FIG. 4, the manifold 40 floats relative to the radial walls of the liners 20 and 30, as it is not connected thereto but rather is spaced from each with a gap. The gap may be filled with spring seals 42 (or any other type of seal) used to seal the manifold 40 while permitting the large thermal differential growth to occur between the cold fuel manifold 40 and the hot combustor liners 20 and 30. The spring seals 42 isolate the manifold 40 to allow thermal expansion at different rates. The ability to deal with the thermal mismatch between the cold manifold 40 and hot combustor liners 20 and 30 is an advantage of the radial combustor geometry shown in FIGS. 2-4. In FIG. 4, the manifold 40 is shown have multiple fuel channels 43, for staging—three are shown, although fewer or more fuel channels 43 could be present.

As opposed to manifolds located outside of the gas generator case, and outside of the combustor, the arrangement shown in FIG. 2 of the manifold 40 located inside the combustor 16 does not require a gas shielding envelope, as the liners 20 and 30 act as heat shields. The manifold 40 is substantially concealed from the hot air circulating outside the combustor 16, as the connection of the manifold 40 with an exterior of the combustor 16 may be limited to the fuel supply line 50 projecting out of the combustor 16. Moreover, in case of manifold leakage, the fuel/flame is contained inside the combustor 16, as opposed to being in the gas generator case. Also, the positioning of the manifold 40 inside the combustor 16 may result in the absence of a combustor dome, and hence of cooling schemes or heat shields. The geometry is such that an annular volume of free space may be defined in the plenum 17 of the turbine case, which may enhance air flow around the combustor 16, and which may allow to increase the diameter of the turbine 18 without impacting the overall engine diameter.

The use of an internal manifold 40 allows the presence of a large number of fuel injection sites 41 comparatively to conventional combustors, lessening the mixing length required and hence allowing radial to axial geometry, resulting in compact combustors. Indeed, radial combustors as the one shown in FIG. 2 are extremely compact and as such simple and lightweight while achieving suitable combustor performance with respect to emissions and gas exit temperature distributions, as compared to conventional long, axial combustors. Large quantities of air normally used in conventional combustor can be devoted to combustion and mixing is small combustors.

The above description is meant to be exemplary only, and one skilled in the art will recognize that changes may be made to the embodiments described without departing from the scope of the invention disclosed. For instance, radial combustors are well suited for engines using radial flow compressors and diffusers. Also, FIG. 2 shows a given combustor geometry, while FIG. 3 shows nozzle air holes N, dilution air holes D and wall cooling holes W, and while FIG. 4 shows another geometry without liner segments 23 and 33, which shows that different liner geometries are possible. Other modifications which fall within the scope of the present invention will be apparent to those skilled in the art, in light of a review of this disclosure, and such modifications are intended to fall within the appended claims.

1. An assembly of a combustor and fuel manifold, the assembly comprising:
a fuel manifold having at least an annular portion with a plurality of fuel outlets facing at least partially radially inward; and
a combustor comprising an annular inner liner and an annular outer liner spaced apart from the inner liner, the inner liner and outer liner concurrently forming an annular combustor chamber therebetween, the inner and outer liners concurrently defining an annular receptacle in the annular combustor chamber for receiving the fuel manifold, the inner liner and outer liners being shaped to define an annular gas path in the annular combustor chamber having an upstream portion that is substantially radial and oriented toward a center when the combustor is in a gas turbine engine.

2. The assembly according to claim 1, wherein the gas path has a downstream portion that is generally axial when the combustor is in a gas turbine engine

3. The assembly according to claim 1, wherein the upstream portion defines a throat subportion downstream of the annular receptacle portion.

4. The assembly according to claim 2, wherein the inner liner and the outer liner converge toward one another in the downstream portion.

5. The assembly according to claim 4, wherein the outer liner is substantially axial at an end of the downstream portion.

6. The assembly according to claim 1, wherein the inner liner has a liner segment defining an outer circumferential surface of the combustor.

7. The assembly according to claim 6, wherein at least one fuel line passage is defined in the outer circumferential surface.

8. The assembly according to claim 6, wherein the liner segment has a tab in circumferential contact with a corresponding circumferential surface of the outer liner for attachment of the liners to one another.

9. The assembly according to claim 8, comprising mechanical fasteners at the circumferential contact to attach the liners to one another.

10. A gas turbine engine comprising:
a combustor comprising an annular inner liner and an annular outer liner spaced apart from the inner liner, the inner liner and outer liner concurrently forming an annular combustor chamber therebetween, the inner and outer liners concurrently defining an annular receptacle in the annular combustor chamber, the inner liner and outer liners being shaped define an annular gas path in the annular combustor chamber having an upstream portion that is substantially radial and oriented toward a center when the combustor is in a gas turbine engine; and
a fuel manifold received in the annular receptacle, the fuel manifold having fuel outlets facing toward a center of the gas turbine engine and adapted to inject fuel radially in the upstream portion of the annular gas path.

11. The gas turbine engine according to claim 10, the gas path having a downstream portion that is generally axial when the combustor is in a gas turbine engine.

12. The gas turbine engine according to claim 10, wherein the upstream portion defines a throat subportion downstream of the annular receptacle portion.

13. The gas turbine engine according to claim 10, wherein the inner liner and the outer liner converge toward one another in the downstream portion.

14. The gas turbine engine according to claim 13, wherein the outer liner is substantially axial at an end of the downstream portion.

15. The gas turbine engine according to claim 10, wherein the inner liner has a liner segment defining an outer circumferential surface of the combustor.

16. The gas turbine engine according to claim 15, wherein at least one fuel line passage is defined in the outer circumferential surface of the liner segment.

17. The gas turbine engine according to claim 15, wherein the liner segment has a tab in circumferential contact with a corresponding circumferential surface of the outer liner for attachment of the liners to one another.

18. The gas turbine engine according to claim 17, comprising mechanical fasteners at the circumferential contact to attach the liners to one another.

19. The gas turbine engine according to claim 10, wherein the fuel manifold is spaced apart from the inner liner and the outer liner, with a gap between the fuel manifold, the inner liner and the outer liner sealed by a spring seal.
